(19) United States
(12) Patent Application Publication
(10) Pub. No.: US 2014/0204417 A1
(43) Pub. Date: Jul. 24, 2014

(54) IMAGE FORMING APPARATUS HAVING PRINTING FUNCTION, CONTROL METHOD THEREFOR, AND STORAGE MEDIUM

(71) Applicant: CANON KABUSHIKI KAISHA, Tokyo (JP)

(72) Inventor: Toru WAKANA, Yokohama-shi (JP)

(73) Assignee: CANON KABUSHIKI KAISHA, Tokyo (JP)

(21) Appl. No.: 14/161,758

(22) Filed: Jan. 23, 2014

(30) Foreign Application Priority Data
Jan. 23, 2013 (JP) 2013-010075

(51) Int. Cl. G06F 3/12

(52) U.S. Cl. CPC G06F 3/1254; G06F 3/1204
USPC 358/1.15

(57) ABSTRACT

An image forming apparatus capable of easily printing print data representing one document based on a plurality of print data stored in an external apparatus. A receiving unit receives first and second print data. A first determination unit determines whether a file name of the first print data and that of the second print data match. A second determination unit determines whether a reception time of the first print data and that of the second print data are included in a predetermined time period. A display unit displays sum of the number of pages of the first print data and that of the second print data as a total number of pages of one document when it is determined that the file names of the first and second print data match and that the reception time of the first and second data are included in the predetermined time period.

### BACKGROUND OF THE INVENTION

1. Field of the Invention

The present invention relates to an image forming apparatus, a control method therefor, and a computer-readable storage medium storing a program for implementing the control method.

2. Description of the Related Art

There are image forming apparatuses capable of receiving print data, which is generated using a printer driver based on document data generated using an application by a host computer, and printing the received print data.

Recently, there has also been used a storing-printing job function using a plurality of image forming apparatuses as explained hereafter. According to this storing-printing job function, first, print data generated using a printer driver is temporarily stored in a storage area of a given image forming apparatus or the like, and the print data is transferred to a different image forming apparatus other than the image forming apparatus in which the print data is stored. The print data is then printed by the different image forming apparatus (see, for example, Japanese Laid-Open Patent Publication (Kokai) No. 2011-59860).

Document data generated using a specific application by a host computer, however, may be divided into a plurality of print data when print data is generated using a printer driver.

In this case, the document data is stored as a plurality of print data in a storage area of an image forming apparatus. The plurality of print data is then displayed on a UI screen of an operation unit of an image forming apparatus that is to print the document data, and hence, when performing the storing-printing function, a user needs to select the plurality of print data, and this is inconvenient from the standpoint of a workflow.

### SUMMARY OF THE INVENTION

The present invention provides an image forming apparatus and a control method therefor, which are capable of easily printing print data, which represents one document, based on a plurality of print data stored in an external apparatus, as well as a computer-readable storage medium storing a program for implementing the control method.

Accordingly, a first aspect of the present invention provides an image forming apparatus comprising a receiving unit configured to receive first print data and second print data, a file name and the number of pages of the first print data and a file name and the number of pages of the second print data, at least, being associated with each other, a first determination unit configured to determine whether a file name of the first print data and a file name of the second print data match, a second determination unit configured to determine whether a reception time of the first print data and a reception time of the second print data are included in a predetermined time period, a display unit configured to, in a case where the first determination unit determines that the file name of the first print data and the file name of the second print data match and in a case where the second determination unit determines that the reception time of the first print data and the reception time of the second print data are included in the predetermined time period, display sum of the number of pages of the first print data and the number of pages of the second print data as a total number of pages of one document.

Accordingly, a second aspect of the present invention provides an image forming apparatus comprising a receiving unit configured to receive first print data and second print data, a file name and the number of pages of the first print data and a file name and the number of pages of the second print data, at least, being associated with each other, a determination unit configured to, in a case where print data is generated using a printer driver, determine whether the first print data and the second print data is data generated by dividing print data for the one document into a plurality of print data, and a display unit configured to, in a case where the determination unit determines that the first print data and the second print data is the data generated by dividing print data for one document into a plurality of print data, display sum of the number of pages of the first print data and the number of pages of the second print data as a total number of pages of the one document.

Accordingly, a third aspect of the present invention provides a control method for an image forming apparatus, comprising a receiving step of receiving first print data and second print data, a file name and the number of pages of the first print data and a file name and the number of pages of the second print data, at least, being associated with each other, a first determination step of determining whether a file name of the first print data and a file name of the second print data match, a second determination step of determining whether a reception time of the first print data and a reception time of the second print data are included in a predetermined time period, a display step of, in a case where it is determined that the file name of the first print data and the file name of the second print data match and in the first determination step and in a case where it is determined that the reception time of the first print data and the reception time of the second print data are included in the predetermined time period in the second determination step, displaying sum of the number of pages of the first print data and the number of pages of the second print data as a total number of pages of one document.

Accordingly, a fourth aspect of the present invention provides a control method for an image forming apparatus, comprising a receiving step of receiving first print data and second print data, a file name and the number of pages of the first print data and a file name and the number of pages of the second print data, at least, being associated with each other, a determination step of, in a case where print data is generated using a printer driver, determining whether the first print data and the second print data is data generated by dividing print data for the one document into a plurality of print data, and a display step of, in a case where it is determined that the first print data and the second print data is the data generated by dividing print data for one document into a plurality of print data in the determination step, displaying sum of the number of pages of the first print data and the number of pages of the second print data as a total number of pages of the one document.

Accordingly, a fifth aspect of the present invention provides a non-transitory computer-readable storage medium storing a program for causing a computer to execute a control method for an image forming apparatus, comprising a receiving step of receiving first print data and second print data, a file name and the number of pages of the first print data and a file name and the number of pages of the second print data, at least, being associated with each other, a first determination step of determining whether a file name of the first print data and a file name of the second print data match, a second determination step of determining whether a reception time of the first print data and a reception time of the second print data are included in a predetermined time period, a display step of, in a case where it is determined that the file name of the first print data and the file name of the second print data match and in the first determination step and in a case where it is determined that the reception time of the first print data and the reception time of the second print data are included in the predetermined time period in the second determination step, displaying sum of the number of pages of the first print data and the number of pages of the second print data as a total number of pages of one document.

Accordingly, a sixth aspect of the present invention provides a non-transitory computer-readable storage medium storing a program for causing a computer to execute a control method for an image forming apparatus, comprising a receiving step of receiving first print data and second print data, a file name and the number of pages of the first print data and a file name and the number of pages of the second print data, at least, being associated with each other, a determination step of, in a case where print data is generated using a printer driver, determining whether the first print data and the second print data is data generated by dividing print data for the one document into a plurality of print data, and a display step of, in a case where it is determined that the first print data and the second print data is the data generated by dividing print data for one document into a plurality of print data in the determination step, displaying sum of the number of pages of the first print data and the number of pages of the second print data as a total number of pages of the one document.

According to the present invention, print data which represents one document can be easily printed based on a plurality of print data stored in an external apparatus.

Further features of the present invention will become apparent from the following description of exemplary embodiments (with reference to the attached drawings).

### BRIEF DESCRIPTION OF THE DRAWINGS

FIG. 1A is a diagram schematically showing an arrangement of an image forming system according to an embodiment of the present invention, and FIG. 1B is a view showing an appearance of an MFP_A.

FIG. 2 is a diagram schematically showing arrangements of a PC, the MFP_A, and MFP_B.

FIGS. 3A to 3D are views showing exemplary screens displayed on a UI screen unit in the present embodiment.

FIGS. 4A and 4B are views showing bibliographic information created in the present embodiment.

FIGS. 5A to 5E are flowcharts showing procedures of an overall process, a printer driver process, a data storage process, a data printing process, and a print data selection process, respectively.

FIG. 6 is a flowchart showing a print data grouping process in step S801 in FIG. 5E.

FIG. 7 is a flowchart showing a print data group grouping process in step S802 in FIG. 5E.

FIGS. 8A and 8B are flowcharts showing procedures of a page creating process and a printing process, respectively.

### DESCRIPTION OF THE EMBODIMENTS

The present invention will now be described in detail with reference to the drawings showing an embodiment thereof.

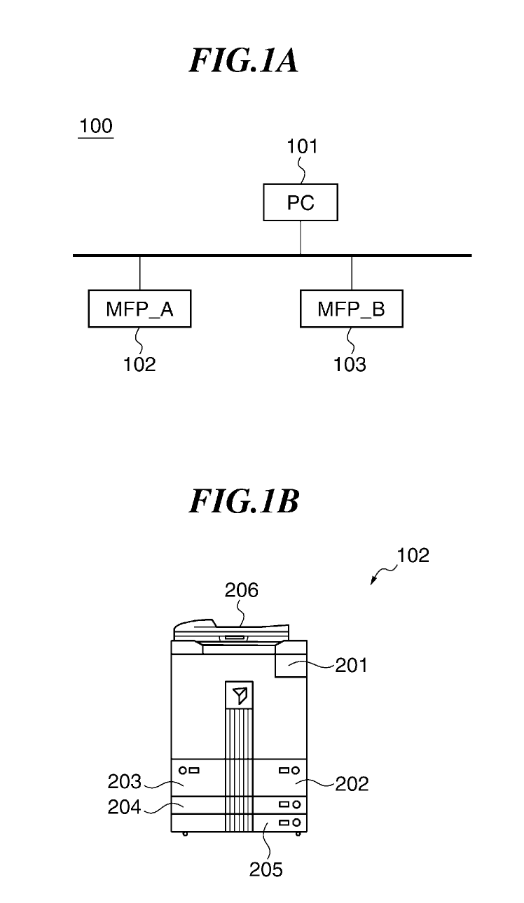

FIG. 1A is a diagram schematically showing an arrangement of an image forming system 100 according to an embodiment of the present invention, and FIG. 1B is a view showing an appearance of an MFP_A 102.

Referring to FIG. 1A, the image forming system 100 is comprised of a PC 101, the MFP_A 102, and an MFP_B 103, which are able to carry out communications with each other via a network.

The PC 101, which is a host computer, creates document data, which represents documents, using an arbitrarily application or the like and creates print data using a printer driver. The MFP_A 102 and the MFP_B 103 are image forming apparatuses, and in the present embodiment, the MFP_A 102 and the MFP_B 103 have the same arrangement.

Although in FIG. 1A, one PC and two image forming apparatuses are shown, the image forming system 100 may be provided with a plurality of PCs and three or more image forming apparatuses.

FIG. 1B shows an appearance of the MFP_A 102 which is an exemplary image forming apparatus. The MFP_A 102 has sheet feeding cassettes 202, 203, 204, and 205 in which printing sheets can be placed. The MFP_A 102 also has an automatic original feeder and a reader 206.

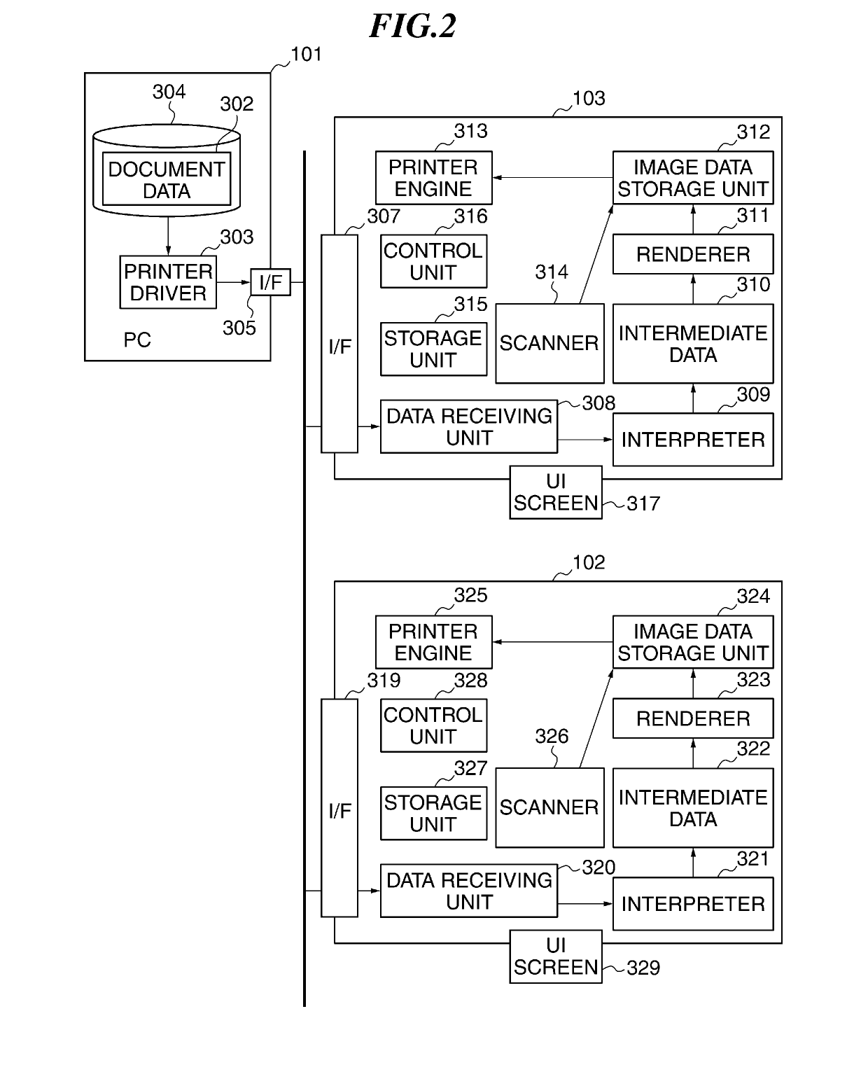

FIG. 2 is a diagram schematically showing arrangements of the PC 101, the MFP_A 102, and the MFP_B 103.

Referring to FIG. 2, the PC 101 has a storage area 304, a printer driver 303, and a communication interface 305.

Document data 302 created using a document creating application, a program for executing the document creating application, and so on are stored in the storage area 304. The printer driver 303 creates PDL (page-description language) data which is print data in page-description languages such as PS, PCL, and LIPS based on the document data 302. The communication interface 305 sends PDL data, which is created by the printer driver 303, to other apparatuses.

A brief description will now be given of an arrangement of the MFP_A 102 and the MFP_B 103. Communication interfaces 307 and 319 are network interfaces to the PC 101 and other image forming apparatuses. Data receiving units 308 and 320 store PDL data received from the network. Interpreter units 309 and 321 interpret received PDL data. It should be noted that the interpreter units 309 and 321 are able to interpret PDL formats such as PS, PCL, and LIPS. It goes without saying that formats other than the above ones may be interpreted.

Intermediate data 310 and 322 is data created through interpretation by the interpreter unit 309. Here, the intermediate data is a generic name for drawing objects such as “bitmap”, “run-length”, “trapezoid”, “box”, and “bitmap encoded at high speed” and background patterns, as well as drawing logics for use in drawing them in raster memory.

Renderers 311 and 323 analyze the intermediate data 310 and 322 and convert the same into image data. Image data obtained as a result of processing by the renderers 311 and 323 is stored in image data storage units 312 and 324. Printer engines 313 and 325 convert image data, which is stored in the image data storage units 312 and 324, into video signals and perform printing.

Scanners 314 and 326 read originals, and images read off the originals are stored as image data in the image data storage units 312 and 324.

Image data stored in the image data storage units 312 and 324 is stored in storage units 315 and 327. Control units 316 and 328 have a CPU and others and control the overall operation of the MFP_A 102 and the MFP_B 103, respectively. UI screens 317 and 329 receive operations from users and display a variety of information for the users.

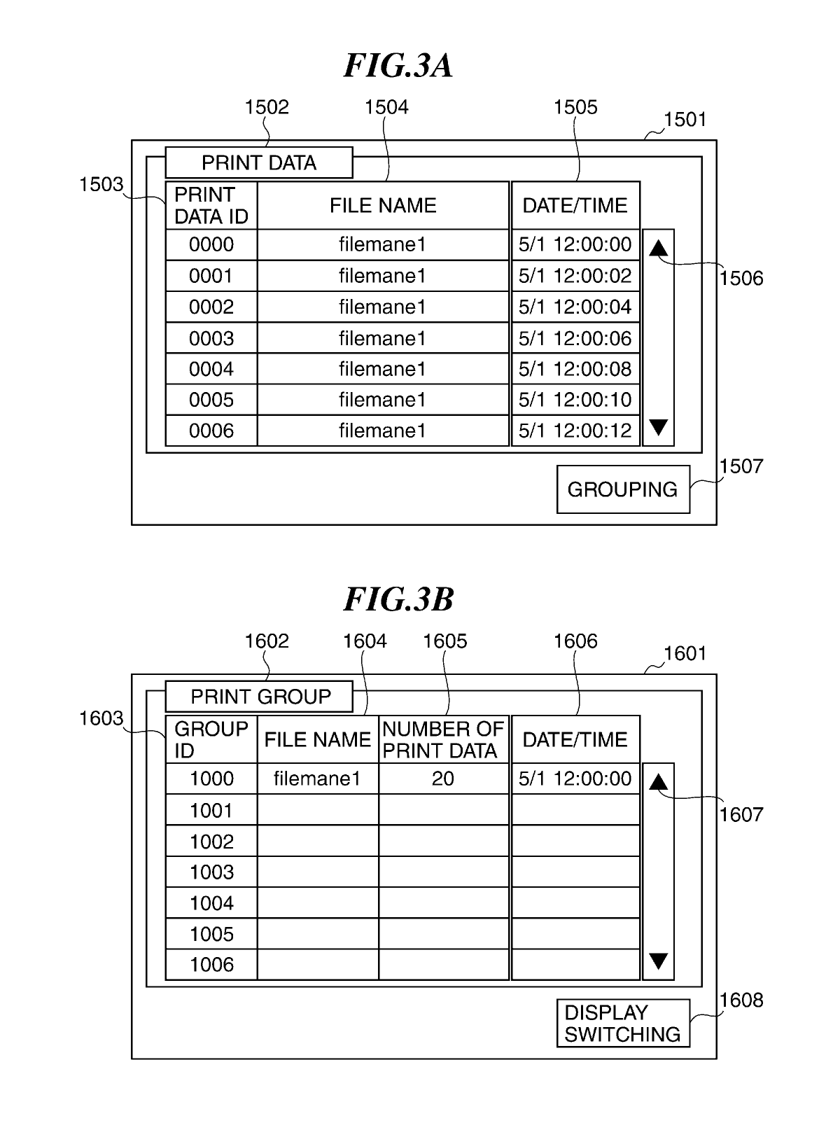

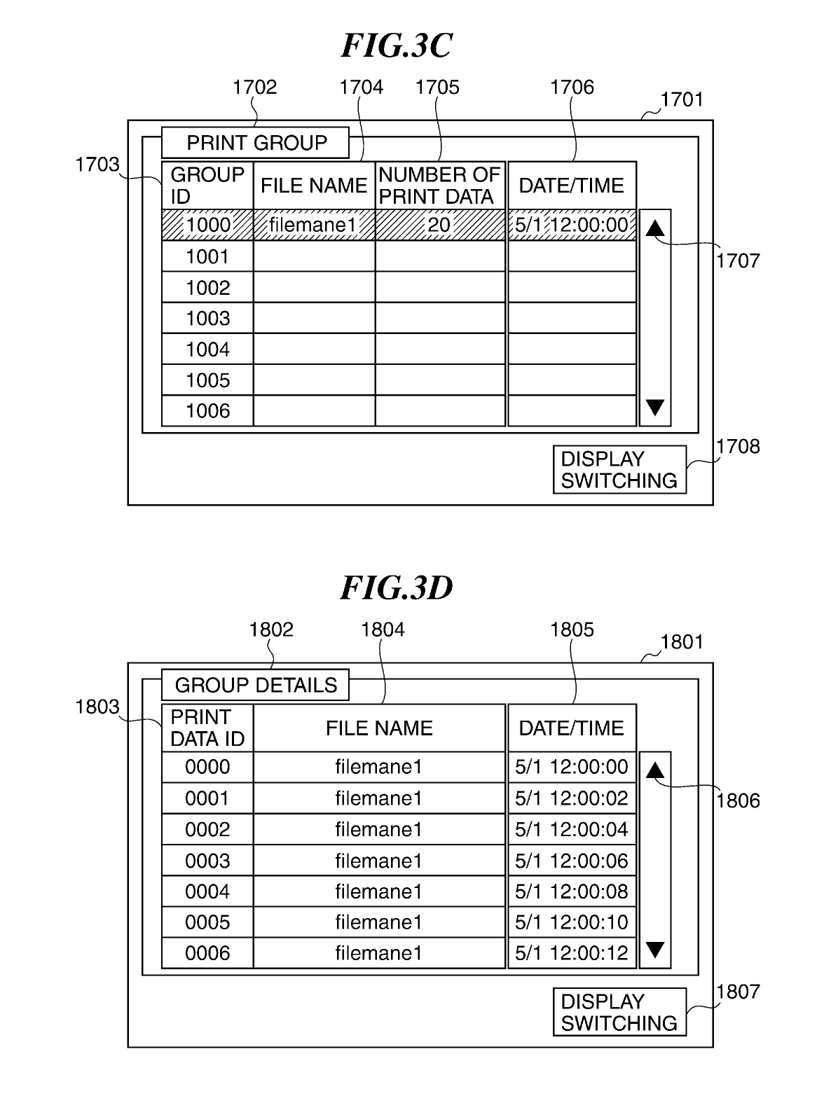

FIGS. 3A to 3D are views showing exemplary screens displayed on the UI screen 317 in the present embodiment.

FIG. 3A is a view showing a print data selection screen 1501. On the print data selection screen 1501 in FIG. 3A, a tab 1502 indicates that a print data screen is being displayed. A heading 1503 indicates a print data ID, a heading 1504 indicates a file name, and a heading 1505 indicates a time at which print data is received.

A scroll bar 1506 is for turning to the next page, and a button 1507 is for grouping. Thus, in the present embodiment, a list of print data is displayed on a display unit (the UI screen 317) using file names to prompt the user to select a file name of print data which he/she intends to print.

FIG. 3B is a view showing a print group selection screen 1601. On the print group selection screen 1601 in FIG. 3B, a tab 1602 indicates that a print group screen is being displayed. A heading 1603 indicates a group ID, a heading 1604 indicates a file name, a heading 1605 indicates the number of grouped print data, and a heading 1606 indicates a time at which print data is received.

A scroll bar 1607 is for turning to the next page, and a button 1608 is for switching displays.

FIG. 3C is a view showing a print group selection screen 1701 on which a group has been selected. On the print group selection screen 1701 in FIG. 3C, a tab 1702 indicates that a print data screen is being displayed. A heading 1703 indicates a group ID, a heading 1704 indicates a file name, a heading 1705 indicates the number of grouped print data, and a title heading indicates a time at which print data is received.

A scroll bar 1707 is for turning to the next page, and a button 1708 is for switching displays. Thus, by means of the print group selection screen 1701, a file name of print data, the number of grouped print data, and a time at which print data received first among grouped print data is received are displayed on the UI screen 317.

FIG. 3D is a view showing a print data details screen 1801. On the print data details screen 1801 in FIG. 3D, a tab 1802 indicates that a print data screen is being displayed. A heading 1803 indicates a print data ID, a heading 1804 indicates a file name, and a heading 1805 indicates a time at which print data is received.

A scroll bar 1806 is for turning to the next page, and a button 1807 is for switching displays. Thus, in the present embodiment, a list of grouped print data is displayed on the UI screen 317.

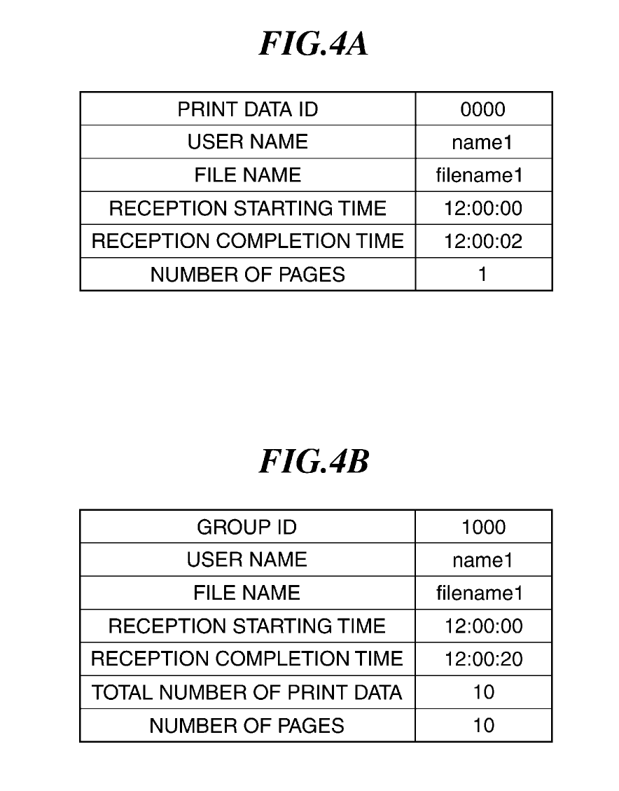

FIGS. 4A and 4B are views showing bibliographic information created according to the present embodiment.

FIG. 4A is a view showing individual bibliographic information created with respect to each PDL data. Referring to FIG. 4A, the individual bibliographic information is comprised of a “print data ID”, a “user name”, a “file name”, a “reception starting time”, a “reception completion time”, and “the number of pages”.

The “print data ID” indicates a number unique to PDL data. In FIG. 4A, the “print data ID” is “0000”. The next “print data ID” is “0001”.

The “user name” indicates a name of a user who transmitted the PDL data from the PC 101. In FIG. 4A, the “user name” is “name1”. A “user name” for the next print data as well is “name1”.

The “file name” indicates a name of document data 302. In FIG. 4A, the “file name” is registered as “filename1”. A “file name” of the next print data as well is “filename1”.

The “reception starting time” indicates a time at which reception of the PDL data is started. In FIG. 4A, the “reception starting time” is “12:00:00”. The “reception completion time” indicates a time at which reception of the PDL data is completed. In FIG. 4A, the “reception completion time” is “12:00:02”.

FIG. 4B is a view showing group bibliographic information created for grouped PDL data. Referring to FIG. 4B, group bibliographic information is comprised of a “group ID”, a “user name”, a “file name”, a “reception starting time”, a “reception completion time”, “the total number of print data”, and “the total number of pages”.

The “group ID” indicates a number unique to the group. In FIG. 4B, the “group ID” is “1000”. The “user name” and the “file name” are the same as those appearing in FIG. 4A.

The “reception starting time” indicates the oldest time among times at which reception of the grouped print data is started. In FIG. 4B, the “reception starting time” is “12:00:00”. Description of the “reception completion time” will be given later. In FIG. 4B, the “reception completion time” is “12:00:20”.

“The total number of print data” indicates the number of grouped print data. In FIG. 4B, “the total number of print data” is “10”. “The total number of pages” indicates the total number of pages of all the grouped print data. In FIG. 4B, “the total number of pages” is “10”.

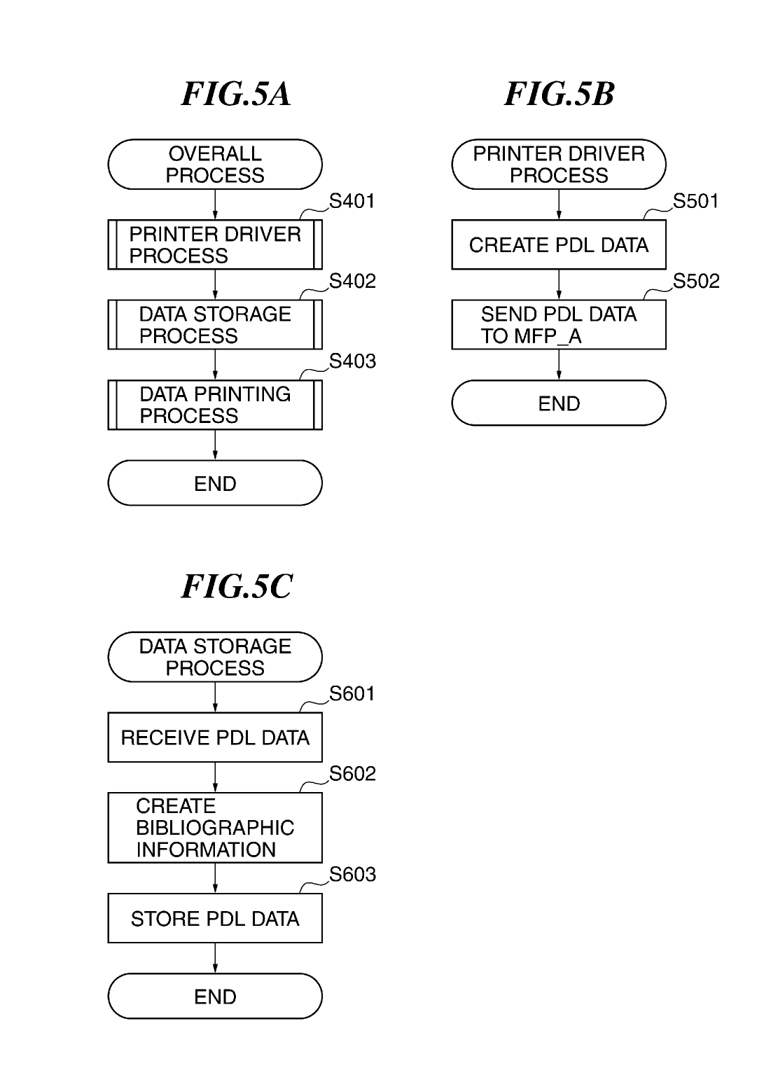

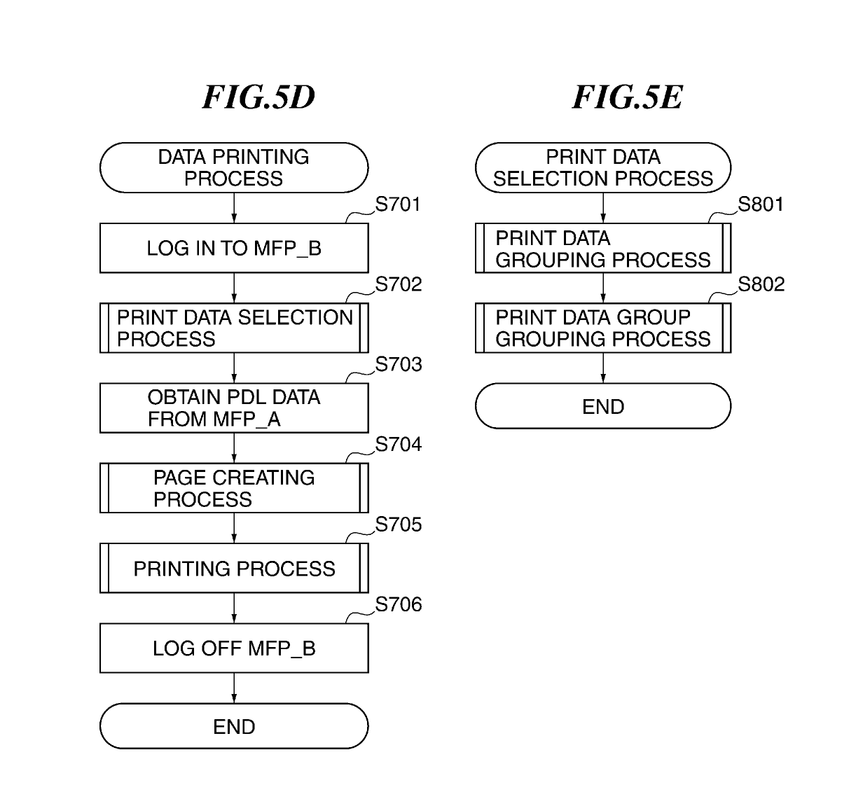

Referring next to flowcharts of FIGS. 5A to 8B, a description will be given of an overall process which is carried out by the PC 101, the MFP_A 102 and the MFP_B 102 according to the present embodiment. The overall process is a process in which print data stored in a given image forming apparatus is printed by a different image forming apparatus.

In the following description of the present embodiment, a process described hereafter is taken as an example of this process. First, the user creates one document data 302 using the PC 101, and PDL data is created based on the document data 302 by the printer driver 303.

Here, a plurality of PDL data is created. In this case, this is handled as a plurality of jobs. Each of the plurality of PDL data is transmitted to the MFP_A 102 and stored in the storage unit 327 of the MFP_A 102. The user then operates the UI screen 317 of the MFP_B 103 to print the PDL data.

Thus, in the present embodiment, an external apparatus in which a plurality of print data representing one document is stored is the MFP_A 102, and an image forming apparatus that receives print data from the MFP_A 102 is the MFP_B 103. Another external apparatus is the PC 101. The bibliographic information described earlier with reference to FIGS. 4A and 4B includes a file names of each print data, and a reception starting time at which an external apparatus (the MFP_A 102) receives the print data from another external apparatus (PC 101).

FIGS. 5A to 5E are flowcharts showing procedures of an overall process, a printer driver process, a data storage process, a data printing process, and a print data selection process, respectively.

FIG. 5A is a flowchart showing the procedure of the overall process which is carried out by the PC 101, the MFP_A 102, and the MFP_B 103 appearing in FIG. 1A.

Referring to FIG. 5A, the PC 101 carries out a printer driver process (step S401). The MFP_A 102 then carries out a data storage process in which it stores PDL data created in the printer driver process (step S402). The MFP_B 103 then carries out a data printing process in which it prints the PDL data stored in the MFP_A 102.

FIG. 5B is a flowchart showing the procedure of the printer driver process in the step S401 in FIG. 5A, which is carried out by the printer driver 303 of the PC 101.

Referring to FIG. 5B, the printer driver 303 creates a plurality of PDL data based on one document data created using an application (step S501).

The printer driver 303 transmits each of the plurality of created PDL data to the MFP_A 102 via the communication interface 305 (step S502) and terminates the present process.

It should be noted that a file name of the document data 302 created by the application is added as “filename1” to each of the plurality of PDL data. Also, information on a user who created the document data 302 using the application is added as “name1” indicative of a user name to each of the plurality of PDL data.

FIG. 5C is a flowchart showing the procedure of the data storage process in the step S402 in FIG. 5A, which is carried out by the control unit 328 of the MFP_A 102.

Referring to FIG. 5C, the control unit 328 receives each of a plurality of PDL data by the data receiving unit 320 (step S601). The control unit 328 then creates bibliographic information (see FIG. 4A) on each of the received plurality of PDL data (step S602).

The control unit 328 then stores the PDL data in the storage unit 327 (step S603) and terminates the present process. At this time, the control unit 328 also stores the created bibliographic information in the storage unit 327.

The bibliographic information created in the step S602 is bibliographic information described hereafter, and for example, a print data ID, a user ID, a file name, a reception starting time, a reception completion time, and the number of pages are written in this order as below.

The first print data: 0000, name1, filename1, 12:00:00, 12:00:02, 1

The second print data: 0001, name1, filename1, 12:00:02, 12:00:04, 1

The third print data: 0002, name1, filename1, 12:00:04, 12:00:06, 1 . . .

In this way, the bibliographic information in which print data is sorted in the order of reception time is created.

FIG. 5D is a flowchart showing the procedure of the data printing process in the step S403 in FIG. 5A, which is carried out by the control unit 316 of the MFP_B 103.

Referring to FIG. 5D, the user logs in to the MFP_B 103 (step S701). It should be noted that the user can log into the MFP_B 103 by bringing an IC card with user information attached thereto into contact with an IC card authenticating section of the UI screen 317 or inputting a password on a login screen of the UI screen 317.

Next, a print data selection process in which print data desired to be printed by the user is selected on the print data selection screen 1501 described above with reference to FIG. 3A is carried out (step S702: selection unit).

The control unit 316 then requests a plurality of PDL data corresponding to the selected print data from the MFP_A 102 and obtains the plurality of PDL data from the MFP_A 102 (step S703).

The control unit 316 then carries out a page creating process in which it converts each of the plurality of PDL data into image data (step S704). The control unit 316 then carries out a printing process in which it converts the image data into video data and performs printing (step S705).

The present process is terminated by the user logging off the MFP_B 103 (step S706). It should be noted that the user can log off the MFP_B 103 by depressing a logout button on the UI screen 317.

FIG. 5E is a flowchart showing the procedure of the print data selection process in the step S702 in FIG. 5D.

Referring to FIG. 5E, the control unit 316 carries out a print data grouping process in which it groups print data (step S801). The control unit 316 then carries out a print data group grouping process in which it further groups the grouped print data (step S802) and terminates the present process.

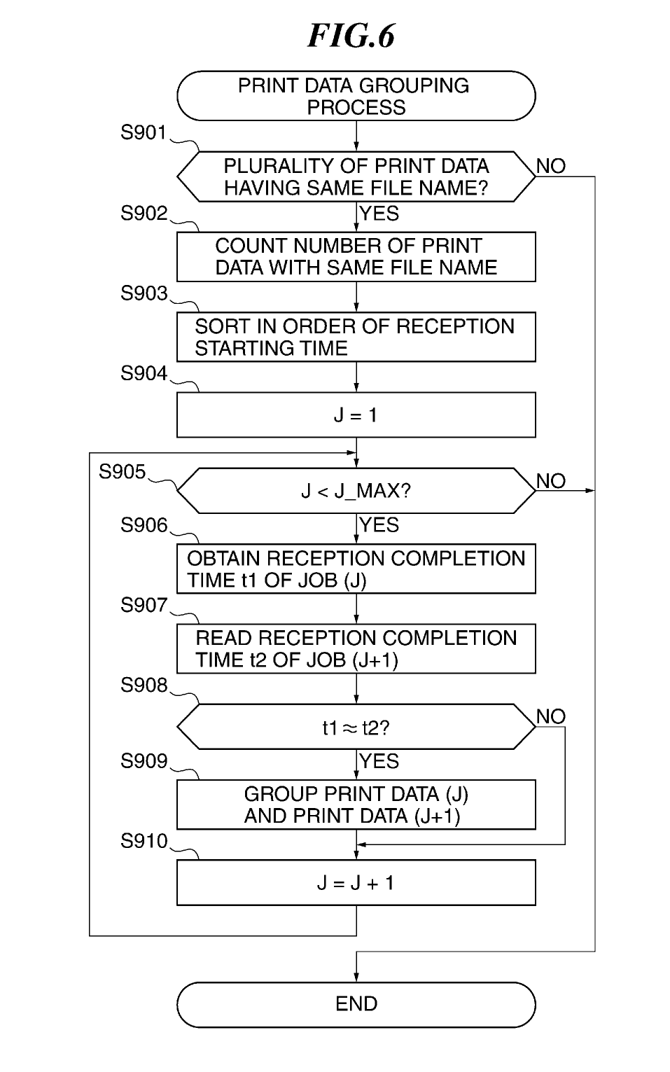

FIG. 6 is a flowchart showing the procedure of the print data grouping process in the step S801 appearing in FIG. 5E.

This process is carried out when the control unit 316 obtains bibliographic information on print data from the MFP_A 102 first, and the user selects, on the print data selection screen 1501 (see FIG. 3A), file names of print data desired to be printed among file names included in the bibliographic information on the obtained print data.

Referring to FIG. 6, by using the bibliographic information obtained from the MFP_A 102, the control unit 316 determines whether or not there is a plurality of print data with the same file name (step S901: identifying unit). When, as a result of the determination in the step S901, there is not a plurality of print data with the same file name (NO in the step S901), the present process is terminated.

On the other hand, when, as a result of the determination in the step S901, there is a plurality of print data with the same file name (YES in the step S901), the control unit 316 counts the number of print data with the same file name (step S902) and sets J_MAX to the counted value.

The control unit 316 then sorts the bibliographic information on the print data with the same file name in order of “reception starting time” from oldest (step S903: sorting unit). The control unit 316 then initializes a parameter J, which is for use in counting the number of print data, to 1 (step S904). In the following description, the Jth print data may be expressed as print data (J).

The control unit 316 determines whether or not the parameter J is smaller than J_MAX (step S905). When, as a result of the determination in the step S905, the parameter J is equal to or greater than J_MAX (NO in the step S905), there is no print data to be processed, and hence the present process is terminated.

On the other hand, when, as a result of the determination in the step S905, the parameter J is smaller than J_MAX (YES in the step S905), the control unit 316 obtains a reception completion time t1 for print data (J) from the bibliographic information (step S906). The control unit 316 then obtains a reception starting time t2 for print data (J+1) from the bibliographic information (step S907).

The control unit 316 then determines whether or not the reception completion time t1 and the reception starting time t2 are substantially the same time “t1≈t2” (step S908). Specifically, substantially the same time means |t1−t2|≦T, and whether or not this holds is determined in the step S908. “T” represents a predetermined time period, which is determined in advance based on network environments, performance of the image forming apparatus, and results of experiments.

When, as a result of the determination in the step S908, the reception completion time t1 and the reception starting time t2 are not substantially the same time “t1≈t2” (NO in the step S908), the control unit 316 determines that the print data (J) and the print data (J+1) are not the same document data, and the process then proceeds to step S910.

On the other hand, when, as a result of the determination in the step S908, the reception completion time t1 and the reception starting time t2 are substantially the same time “t1≈t2” (YES in the step S908), the control unit 316 determines that the print data (J) and the print data (J+1) are print data of the same document data and groups the print data (J) and the print data (J+1) (step S909: grouping unit).

At this time, group bibliographic information (see FIG. 4B) is created. A “group ID” in the bibliographic information is, for example, “1000”. A “user name” is the same as that in individual bibliographic information. A “file name” is the same as that in individual bibliographic information. A “reception starting time” is the oldest time among the grouped print data. A “reception completion time” is t2.

The control unit 316 then increments the parameter J (step S910), and the process returns to the step S905. As a result of this process, the display switches from the print data selection screen 1501 in FIG. 3A to the print group selection screen 1601 in FIG. 3B. In the heading 1605, a value of J_MAX is displayed to indicate the total number of print data after grouping.

As shown in FIG. 3C, when the user selects a group ID 1000 and depresses the button 1708, the print data details screen 1801 appearing in FIG. 3D is displayed. As a result, the user can look at details of the grouped print data.

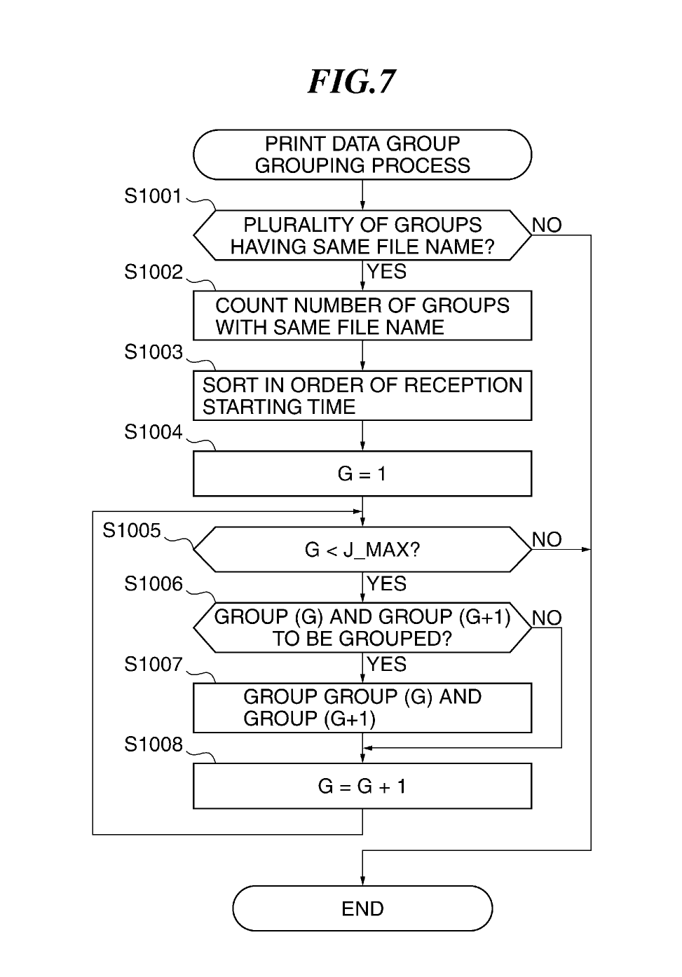

FIG. 7 is a flowchart showing the procedure of the print data group grouping process in the step S802 in FIG. 5E.

This process is to make a recovery when print data that should have been grouped was not grouped. For example, in a case where, when a user is sending a plurality of print data, another user sends other print data, the result of the determination in the step S909 in FIG. 6 as to whether or not “t1≈t2” is negative, and as a result, print data that should be grouped may not be grouped.

Referring to FIG. 7, the control unit 316 determines whether or not the there is a plurality of groups with the same file name (step S1001). When, as a result of the determination in the step S1001, there is not a plurality of groups with the same file name (NO in the step S1001), the present process is terminated.

On the other hand, when, as a result of the determination in the step S1001, there is a plurality of groups with the same file name (YES in the step S1001), the control unit 316 counts the number of groups with the same file name based on bibliographic information (step S1002) and sets J_MAX to the counted value.

The control unit 316 then sorts the bibliographic information on the groups with the same file name in order of “reception starting time” from oldest (step S1003). The control unit 316 then initializes a parameter G, which is for use in counting the number of groups, to 1 (step S1004). In the following description, the Gth group may be expressed as a group (G).

The control unit 316 determines whether or not the parameter G is smaller than J_MAX (step S1005). When, as a result of the determination in the step S1005, the parameter G is equal to or greater than J_MAX (NO in the step S1005), there is no group to be processed, and hence the present process is terminated.

On the other hand, when, as a result of the determination in the step S1005, the parameter G is smaller than J_MAX (YES in the step S1005), the control unit 316 displays, on the UI screen 317, a screen for making a determination as to whether or not to group a group (G) and a group (G+1).

It is determined whether or not the user has issued an instruction to group the group (G) and the group (G+1) (step S1006). When, as a result of the determination in the step S1006, the group (G) and the group (G+1) are not to grouped (NO in the step S1006), the process proceeds to step S1008.

On the other hand, when, as a result of the determination in the step S1006, the group (G) and the group (G+1) are to be grouped into a group (YES in the step S1006), the control unit 316 groups the group (G) and the group (G+1) (step S1007).

The control unit 316 then increments the parameter G (step S1008), and the process returns to the step S1005. The print data group grouping process described above corresponds to a regrouping unit.

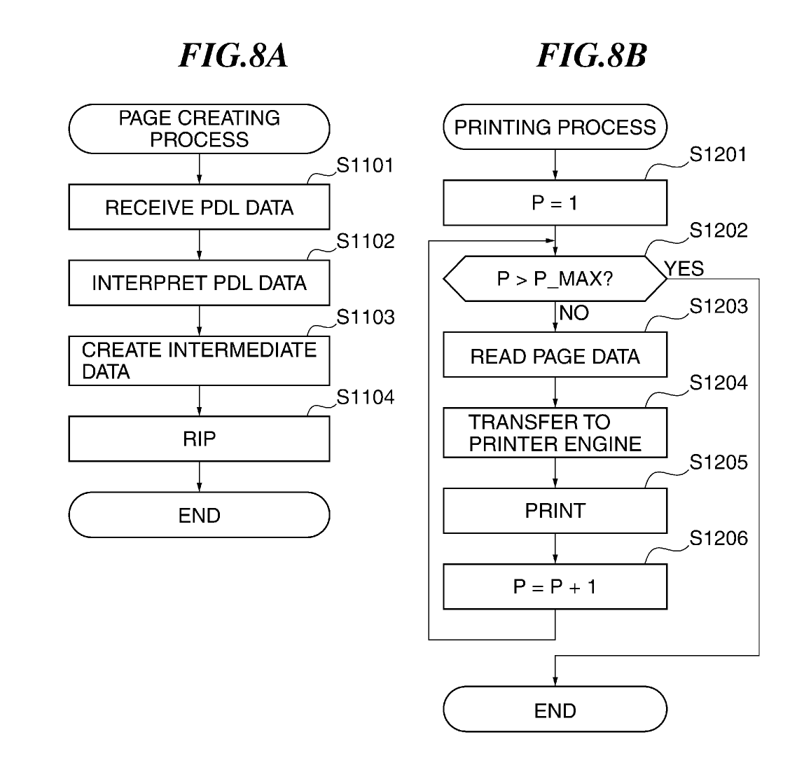

FIGS. 8A and 8B are flowcharts showing procedures of the page creating process and the printing process, respectively.

FIG. 8A is a flowchart showing the procedure of the page creating process in the step S704 in FIG. 5D. Referring to FIG. 8A, the control unit 316 receives PDL data transmitted from the MFP_A 102 (step S1101).

The interpreter unit 309 interprets the received PDL data (step S1102). The control unit 316 then creates intermediate data 310 based on the PDL data interpreted by the interpreter unit 309 (step S1103).

The control unit 316 then subjects the intermediate data 310 to RIP (step S1104) and terminates the present process.

Here, RIP means a process in which the renderer 311 converts the intermediate data 310 into image data and stores the image data in the image data storage unit 312. Thereafter, the control unit 316 sets P_MAX, which is for use in the next printing process, to the total number of pages.

FIG. 8B is a flowchart showing the procedure of the printing process in the step S705 in FIG. 5D. Referring to FIG. 8B, the control unit 316 initializes a parameter P, which represents the number of pages, to (step S1201). In the following description, the Pth page may be expressed as a page (P).

The control unit 316 determines whether or not the parameter P is greater than P_MAX (step S1202). When, as a result of the determination in the step S1202, the parameter P is greater than P_MAX (YES in the step S1202), there is no page to be processed, and hence the present process is terminated.

On the other hand, when, as a result of the determination in the step S1202, the parameter P is equal to or smaller than P_MAX (NO in the step S1202), the control unit 316 reads image data of a page being processed (P) from the storage unit 315 (step S1203) and stores the image data in the storage unit 312.

The control unit 316 then converts the image data stored in the image data storage unit 312 into video data and transfers the video data to the printer engine 313 (step S1204). The control unit 316 then feeds a recording sheet from any of the sheet feeding cassettes 202, 203, 204, and 205 and causes the printer engine 313 to print the transferred video data (step S1205).

The control unit 316 then increments the parameter P (step S1206), and the process returns to the step S1202. The page creating process and the printing process described above with reference to FIGS. 8A and 8B correspond to a printing unit.

According to the embodiment described above, because a plurality of print data which represents one document is grouped, a plurality of print data which represents one document stored in an external apparatus can be easily printed.

Specifically, even when a plurality of print data is created from one document, selecting one file name causes the plurality of print data to be grouped, and hence a file name can be easily selected.

Moreover, because all of grouped print data are displayed on the image forming apparatus as shown in FIG. 3D, details of the grouped print data can be easily grasped.

Further, because post-grouping print data and pre-grouping print data can be selectively displayed as shown in FIGS. 3C and 3D, convenience can be enhanced.

Further, as shown in FIG. 7, even when print data that should have been grouped was not grouped, a recovery can be made by further grouping groups, and hence convenience can be enhanced.

Although in the embodiment described above, a group is formed by the user selecting a file name, print data may be grouped by automatically carrying out the print data grouping process and the print data group grouping process described with reference to FIG. 5E, and after that, print data in a group selected on the screen shown in FIG. 3C or 3D may be printed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-010075 filed Jan. 23, 2013, which is hereby incorporated by reference herein in its entirety.

What is claimed is:

1. An image forming apparatus comprising:
a receiving unit configured to receive first print data and second print data, a file name and the number of pages of the first print data and a file name and the number of pages of the second print data, at least, being associated with each other;
a first determination unit configured to determine whether a file name of the first print data and a file name of the second print data match;
a second determination unit configured to determine whether a reception time of the first print data and a reception time of the second print data are included in a predetermined time period;
a display unit configured to, in a case where said first determination unit determines that the file name of the first print data and the file name of the second print data match and in a case where said second determination unit determines that the reception time of the first print data and the reception time of the second print data are included in the predetermined time period, display sum of the number of pages of the first print data and the number of pages of the second print data as a total number of pages of one document.

2. The image forming apparatus according to claim 1, further comprising:
a selection unit configured to prompt a user to select the file name of the first print data or the file name of the second print data, and
a sorting unit configured to, in response to said selection unit selecting the file name of the first print data or the file name of the second print data, sort the first print data and the second print data in order of the respective reception time.

3. The image forming apparatus according to claim 2, wherein said display unit is configured to display a reception time of print data which has been received first between the first print data and the second print data.

4. The image forming apparatus according to claim 1, further comprising a printer configured to print an image based on the first print data or the second print data received by said receiving unit.

5. The image forming apparatus according to claim 1, further comprising a switching unit configured to switch whether to display the first print data is displayed independently from the second print data or to display the first print data and the second print data as the one document.

6. An image forming apparatus comprising;
a receiving unit configured to receive first print data and second print data, a file name and the number of pages of the first print data and a file name and the number of pages of the second print data, at least, being associated with each other;
a determination unit configured to, in a case where print data is generated using a printer driver, determine whether the first print data and the second print data is data generated by dividing print data for the one document into a plurality of print data; and
a display unit configured to, in a case where said determination unit determines that the first print data and the second print data is the data generated by dividing print data for one document into a plurality of print data, display sum of the number of pages of the first print data and the number of pages of the second print data as a total number of pages of the one document.

7. A control method for an image forming apparatus, comprising:
a receiving step of receiving first print data and second print data, a file name and the number of pages of the first print data and a file name and the number of pages of the second print data, at least, being associated with each other;
a first determination step of determining whether a file name of the first print data and a file name of the second print data match;
a second determination step of determining whether a reception time of the first print data and a reception time of the second print data are included in a predetermined time period;
a display step of, in a case where it is determined that the file name of the first print data and the file name of the second print data match and in said first determination step and in a case where it is determined that the reception time of the first print data and the reception time of the second print data are included in the predetermined time period in said second determination step, displaying sum of the number of pages of the first print data and the number of pages of the second print data as a total number of pages of one document.

8. A control method for an image forming apparatus, comprising:
a receiving step of receiving first print data and second print data, a file name and the number of pages of the first print data and a file name and the number of pages of the second print data, at least, being associated with each other;
a determination step of, in a case where print data is generated using a printer driver, determining whether the first print data and the second print data is data generated by dividing print data for the one document into a plurality of print data; and
a display step of, in a case where it is determined that the first print data and the second print data is the data generated by dividing print data for one document into a plurality of print data in said determination step, displaying sum of the number of pages of the first print data and the number of pages of the second print data as a total number of pages of the one document.

9. A non-transitory computer-readable storage medium storing a program for causing a computer to execute a control method for an image forming apparatus, comprising:
a receiving step of receiving first print data and second print data, a file name and the number of pages of the first print data and a file name and the number of pages of the second print data, at least, being associated with each other;
a first determination step of determining whether a file name of the first print data and a file name of the second print data match;
a second determination step of determining whether a reception time of the first print data and a reception time of the second print data are included in a predetermined time period;
a display step of, in a case where it is determined that the file name of the first print data and the file name of the second print data match and in said first determination step and in a case where it is determined that the reception time of the first print data and the reception time of the second print data are included in the predetermined time period in said second determination step, displaying sum of the number of pages of the first print data and the number of pages of the second print data as a total number of pages of one document.

10. A non-transitory computer-readable storage medium storing a program for causing a computer to execute a control method for an image forming apparatus, comprising:
a receiving step of receiving first print data and second print data, a file name and the number of pages of the first print data and a file name and the number of pages of the second print data, at least, being associated with each other;
a determination step of, in a case where print data is generated using a printer driver, determining whether the first print data and the second print data is data generated by dividing print data for the one document into a plurality of print data; and
a display step of, in a case where it is determined that the first print data and the second print data is the data generated by dividing print data for one document into a plurality of print data in said determination step, displaying sum of the number of pages of the first print data and the number of pages of the second print data as a total number of pages of the one document.
